(19) United States
(12) Patent Application Publication
(10) Pub. No.: US 2025/0353716 A1
(43) Pub. Date: Nov. 20, 2025

(54) DETECTION MECHANISM AND STACKER CRANE

(71) Applicant: GUANGDONG LEAD INTELLIGENT LOGISTICS TECHNOLOGY CO.,LTD., Zhuhai (CN)

(72) Inventors: Wenkai ZHOU, Zhuhai (CN); Pengfei ZHU, Zhuhai (CN); Suyou MENG, Zhuhai (CN)

(21) Appl. No.: 19/286,461

(22) Filed: Jul. 31, 2025

Related U.S. Application Data
(63) Continuation of application No. PCT/CN2024/101680, filed on Jun. 26, 2024.

(30) Foreign Application Priority Data
Sep. 25, 2023 (CN) 202322614800.X

(51) Int. Cl. B66F 9/07; B66F 9/075

(52) U.S. Cl. CPC B66F 9/07; B66F 9/0755

(57) ABSTRACT

A detection mechanism and a stacker crane is provided. The detection mechanism includes a position detector, an anti-collision member, and an adjustment assembly. The position detector includes a contact movable along a first direction. The anti-collision member is movable relative to the position detector between a first state and a second state along the first direction. The adjustment assembly is connected between the anti-collision member and the contact. When the anti-collision member is in the first state, the contact is in a triggering position and triggers the position detector to send a collision signal. When the anti-collision member is in the second state, the contact is in a standby position. The adjustment assembly is movable relative to the anti-collision member to adjust the distance between the triggering position and the standby position. The stacker crane includes the detection mechanism.

### CROSS-REFERENCE TO RELATED APPLICATIONS

The present application is a U.S. Continuation of International Application PCT/CN2024/101680 filed on Jun. 26, 2024, which claims priority to Chinese Patent Application No. 202322614800.X and entitled “DETECTION MECHANISM AND STACKER CRANE” filed with the China National Intellectual Property Administration on Sep. 25, 2023, and the content of the aforementioned applications is incorporated herein by reference in its entirety.

### TECHNICAL FIELD

The present disclosure relates to the field of transportation devices, and more particularly, to a detection mechanism and a stacker crane including the detection mechanism.

### BACKGROUND

A stereoscopic warehouse may pick and place goods through a stacker crane. However, due to the inaccurate positioning of the stacker crane, the fork extending from the stacker crane may hit an obstacle, such as goods or a crossbeam and other related items. Especially in the lithium battery industry, hitting expensive goods (such as batteries or electrode rolls) on the shelf may cause the goods to fall and be damaged. If it is a charged battery, it may even cause a short circuit of the battery and thus lead to a fire.

An anti-collision structure is usually provided on the fork to prevent a direct collision between the fork and an obstacle. The anti-collision structure needs to be triggered by a limit switch, and the triggering of the limit switch is related to the triggering stroke of its own contact. However, the triggering stroke of the existing limit switch is relatively long, so a large displacement is required for the anti-collision structure to trigger the limit switch under the condition that a collision occurs. As a result, it is likely that the fork cannot stop its action in time and still collides with the obstacle, causing losses.

### SUMMARY

The present disclosure aims to alleviate or address at least one of the above-mentioned problems to at least a certain extent.

According to a first aspect of the present disclosure, a detection mechanism is provided. A position detector includes a contact that is movable along a first direction. An anti-collision member is movable relative to the position detector between a first state and a second state along the first direction. An adjustment assembly is connected between the anti-collision member and the contact. When the anti-collision member is in the first state, the contact is in a triggering position and triggers the position detector to send a collision signal, and when the anti-collision member is in the second state, the contact is in a standby position. The adjustment assembly is movable relative to the anti-collision member to adjust a distance between the triggering position and the standby position.

In some embodiments, the detection mechanism further includes a fixing member, the fixing member being fixedly arranged relative to the position detector; an extension rod, the extension rod extending along the first direction. A first end of the extension rod being is connected to the anti-collision member. A second end of the extension rod is connected to the adjustment assembly. A first elastic member is telescopic in the first direction and connected between the anti-collision member and the fixing member.

In some embodiments, the adjustment assembly includes an adjustment member, the adjustment member connected to the second end of the extension rod, and movable relative to the extension rod along the first direction. The adjustment member is provided with a first limit portion. A push rod extends along the first direction. One end of the push rod away from the anti-collision member abuts against the contact. The push rod is provided with a first matching portion. The first matching portion is located on a side of the first limit portion adjacent to the anti-collision member. A second elastic member is being telescopic in the first direction. A first end of the second elastic member abuts against the extension rod. A second end of the second elastic member abuts against the push rod, and presses the first matching portion against the first limit portion.

In some embodiments, the adjustment member includes a sleeve extending along the first direction. A first end of the sleeve is sleeved on the second end of the extension rod and screwed with the extension rod. One end of the push rod adjacent to the anti-collision member extends into a second end of the sleeve. The first limit portion is provided on an inner wall surface of the sleeve and protruding into the sleeve. The first matching portion is provided on an outer circumferential surface of the push rod and protruding outward. The second elastic member provided in the sleeve.

In some embodiments, one end of the fixing member away from the anti-collision member is provided with a second limit portion. The extension rod is provided with a second matching portion. The second matching portion is located on a side of the second limit portion away from the anti-collision member. When the anti-collision member is in the first state, the second limit portion is spaced apart from the second matching portion, and when the anti-collision member is in the second state, the second limit portion abuts against the second matching portion.

In some embodiments, the fixing member is a linear bearing. The linear bearing is sleeved on the extension rod.

In some embodiments, the position detector is a wireless limit switch.

In some embodiments, the fixing member is a linear bearing. The linear bearing is sleeved on the extension rod. The first elastic member is a spring and sleeved on the extension rod. One end of the first elastic member adjacent to the anti-collision member is connected to the anti-collision member. One end of the first elastic member away from the anti-collision member is connected to one end surface of the fixing member facing the anti-collision member.

In some embodiments, the push rod and the adjustment member are arranged at intervals along a radial direction of the push rod. The first limit portion is a first protrusion on the adjustment member protruding towards the push rod. The first matching portion is a second protrusion on the push rod protruding towards the adjustment member. The first protrusion and the second protrusion abut against each other in the first direction.

In some embodiments, the second end of the extension rod is provided with a prolonged rod. The prolonged rod includes a diameter less than a diameter of the second end of the extension rod. The push rod includes a channel. The channel penetrates the push rod along the first direction. The channel includes a stair. The second elastic member is a spring. One end of the spring is adjacent to the anti-collision member sleeved on the prolonged rod. One end of the spring away from the anti-collision member extends into the channel of the push rod and abutting against the stair.

In some embodiments, the push rod, the extension rod, and the sleeve are coaxially arranged.

In some embodiments, one end surface of the fixing member away from the anti-collision member is provided with a limit groove. The limit groove is recessed in a direction facing the anti-collision member. A bottom surface of the limit groove forms the second limit portion. The first matching portion is an annular boss. The annular boss protrudes outward along a radial direction of the extension rod. One side surface of the annular boss adjacent to the anti-collision member abuts against the bottom surface of the limit groove.

According to a second aspect of the present disclosure, a stacker crane is provided, including: a main body; a supporting member, the supporting member being movably arranged on the main body along the first direction, and the supporting member being used for supporting a member to be supported; a driving member, the driving member being connected to the supporting member and driving the supporting member to move along the first direction; at least one detection mechanism, the detection mechanism being the detection mechanism according to any one of the above embodiments, the position detector being arranged on the supporting member, and the anti-collision member protruding from the supporting member in the first direction.

In some embodiments, the anti-collision member is an anti-collision plate. A projection of the anti-collision plate along the first direction covers a projection of the supporting member along the first direction.

In some embodiments, the anti-collision plate is recessed towards the supporting member and forms an avoidance groove.

In some embodiments, the at least one detection mechanism includes two detection mechanisms. The two detection mechanisms are respectively arranged at two ends of the supporting member in the first direction.

In some embodiments, the supporting member includes two fork arms. The two fork arms respectively extend along the first direction and are spaced apart in a second direction. The second direction intersects with the first direction. The position detector is arranged on one of the two fork arms. A guiding mechanism is arranged on another one of the two fork arms for guiding the anti-collision member to move along the first direction.

In some embodiments, the stacker crane further includes a wireless receiver. The wireless receiver wirelessly is connected to the position detector to receive the collision signal. The wireless receiver is electrically connected to the driving member and configured to control the driving member according to the collision signal.

In some embodiments, the adjustment assembly is a telescopic rod extending along the first direction, the telescopic rod is driven by the driving member.

In some embodiments, the guiding mechanism includes a linear bearing, a guide rod, and a third elastic member. The linear bearing is fixed on the fork arms. One end of the guide rod is connected to the anti-collision member and another end of the guide rod extends into the linear bearing. The guide rod is moveable along the first direction. The third elastic member is connected between the anti-collision member and the linear bearing of the guiding mechanism.

According to an exemplary detection mechanism of the present disclosure, by arranging the adjustment assembly between the anti-collision member and the position detector, the distance between the triggering position and the standby position of the contact in the position detector may be adjusted, that is, the stroke required for the contact to trigger the position detector to send a collision signal may be adjusted, so as to adjust the displacement of the anti-collision member corresponding to the collision feedback generated by the detection mechanism. Therefore, the displacement may be shortened according to demand to improve the detection accuracy of the position detector, make the collision detection of the detection mechanism more sensitive, accelerate the collision response speed and reduce the harm of the collision.

Through the following detailed description of the exemplary embodiments of the present disclosure with reference to the accompanying drawings, other features and advantages of the present disclosure will become clear.

### BRIEF DESCRIPTION OF THE DRAWINGS

The above and/or additional aspects and advantages of the present disclosure will become apparent and readily understood from the description of the embodiments in conjunction with the following drawings, in which:

FIG. 1 is a perspective view of a portion of the structure of the detection mechanism according to an embodiment of the present disclosure;

FIG. 2 is a front view of a portion of the structure of the detection mechanism according to an embodiment of the present disclosure;

FIG. 3 is a sectional view taken along line A-A in FIG. 2;

FIG. 4 is a perspective view of the stacker crane according to an embodiment of the present disclosure;

FIG. 5 is a front view of the stacker crane according to an embodiment of the present disclosure;

FIG. 6 is a top view of the stacker crane according to an embodiment of the present disclosure;

FIG. 7 is a bottom view of the stacker crane according to an embodiment of the present disclosure;

FIG. 8 is an enlarged view of the portion circled at B in FIG. 7; and

FIG. 9 is schematic side view of the stacker crane and the shelf according to an embodiment of the present disclosure.

### EXPLANATION OF THE REFERENCE NUMERALS IN THE DRAWINGS

Detection mechanism 100;
Position detector 10; Contact 12;
Anti-collision member 20; Avoidance groove 21;
Adjustment assembly 30; Sleeve 31; First limit portion 311; Push rod 32; First matching portion 321; Matching surface 3211; Annular boss 322; Second elastic member 33; Nut 34;
Fixing member 41; Second limit portion 411; Extension rod 42; Second matching portion 421; First elastic member 43;
Main body 200;
Supporting member 300; Fork arm 301;
Driving member 400; Wireless receiver 500;
Member to be supported 600;
Guiding mechanism 700; Linear bearing 701, Guide rod 702, and Third elastic member 703;
Shelf 800; and Stacker Crane 1000.

### DETAILED DESCRIPTION

Various exemplary embodiments of the present disclosure will now be described in detail with reference to the accompanying drawings. It should be noted that unless specifically stated otherwise, the relative arrangements, numerical expressions and numerical values of the components and steps set forth in these embodiments do not limit the scope of the present disclosure.

The following description of at least one exemplary embodiment is in fact merely illustrative and by no means serves as any limitation to the present disclosure and its application or use.

The techniques, methods and devices known to the person having ordinary skill in the relevant art may not be discussed in detail, but they should be regarded as part of the specification when appropriate.

In all the examples shown and discussed herein, any specific value should be interpreted as merely exemplary and not as a limitation. Therefore, other examples of the exemplary embodiments may have different values.

It should be noted that similar reference numerals and letters in the following drawings denote similar items. Therefore, once an item is defined in one drawing, it does not need to be further discussed in subsequent drawings.

Hereinafter, at least one detection mechanism 100 according to the embodiments of the present disclosure will be specifically described in combination with the accompanying drawings.

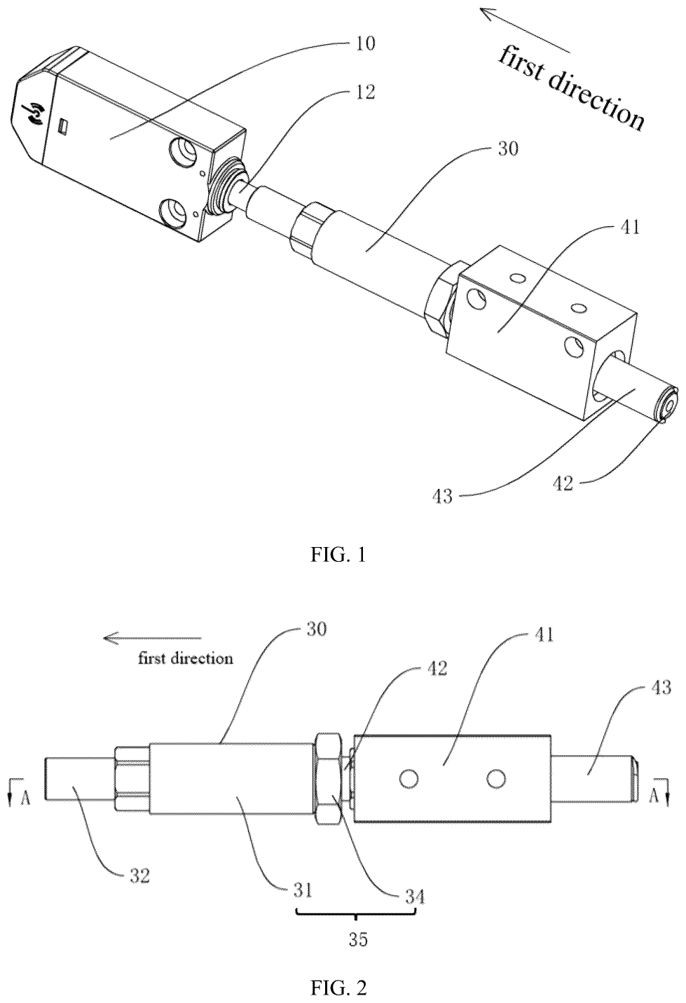

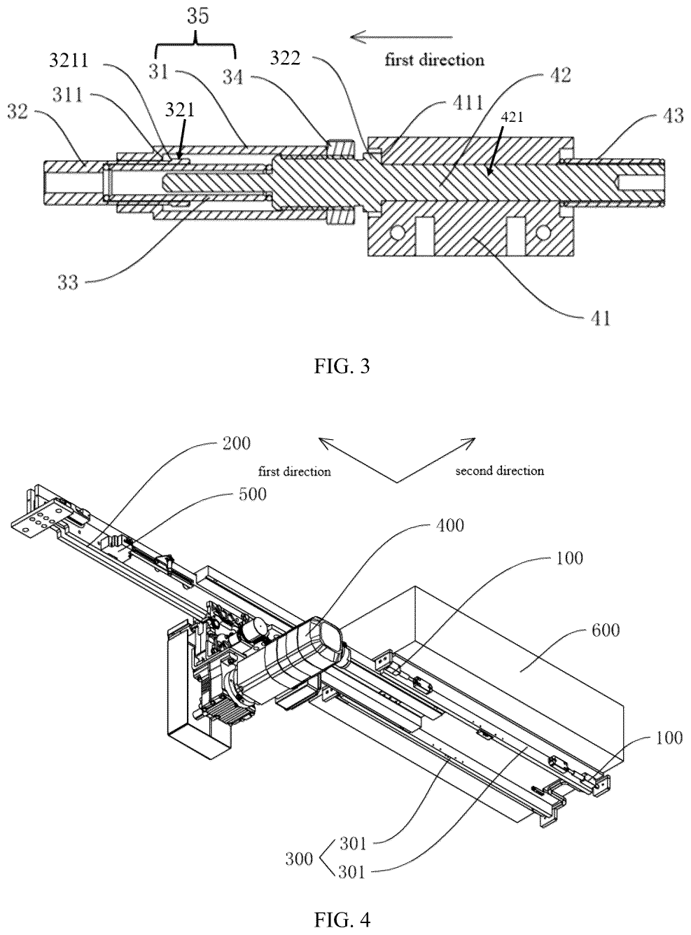

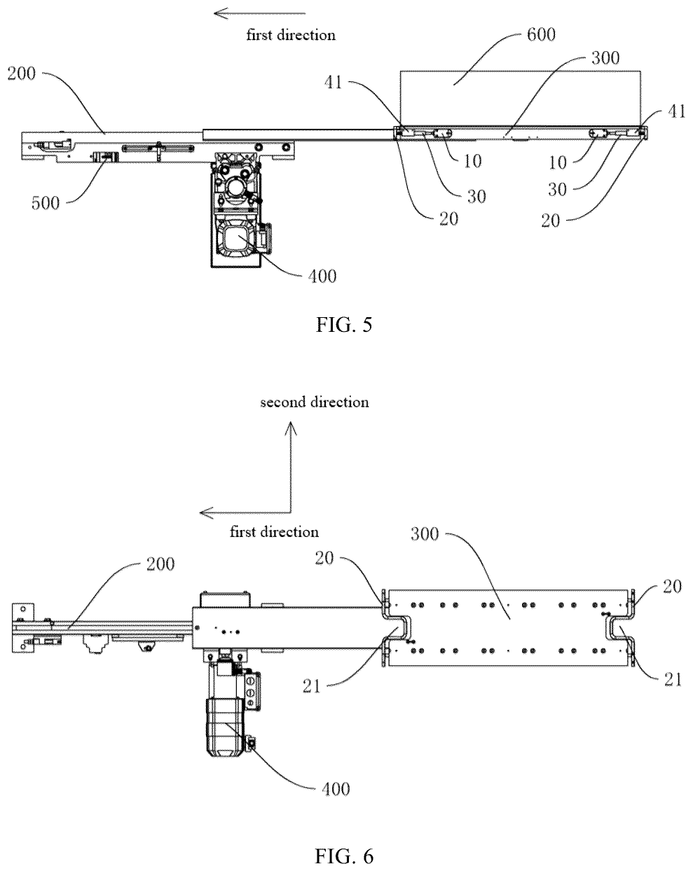

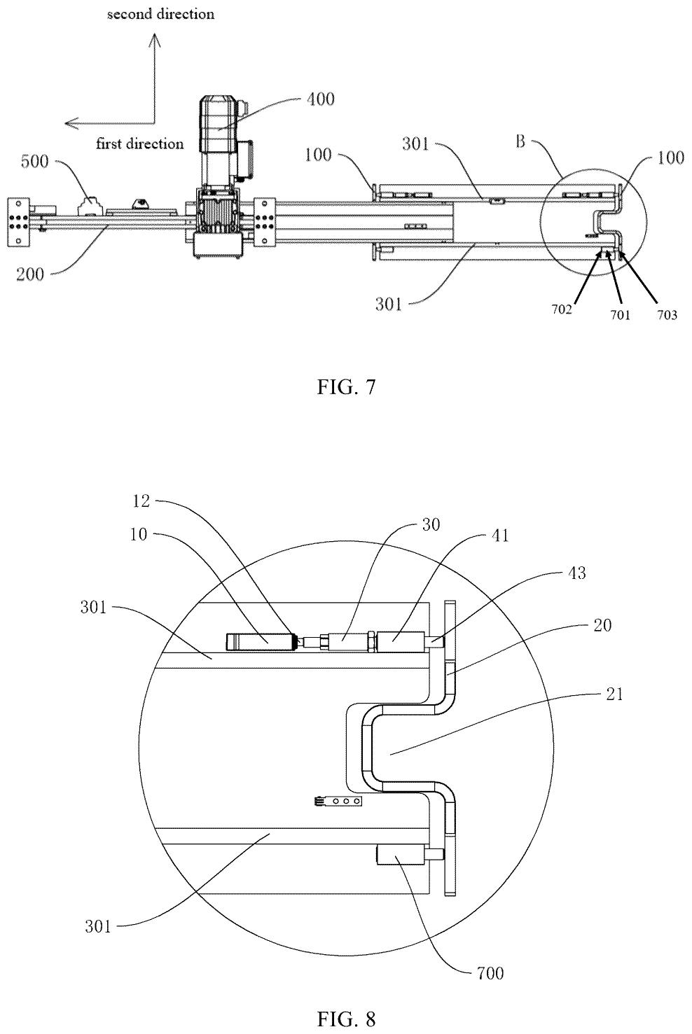

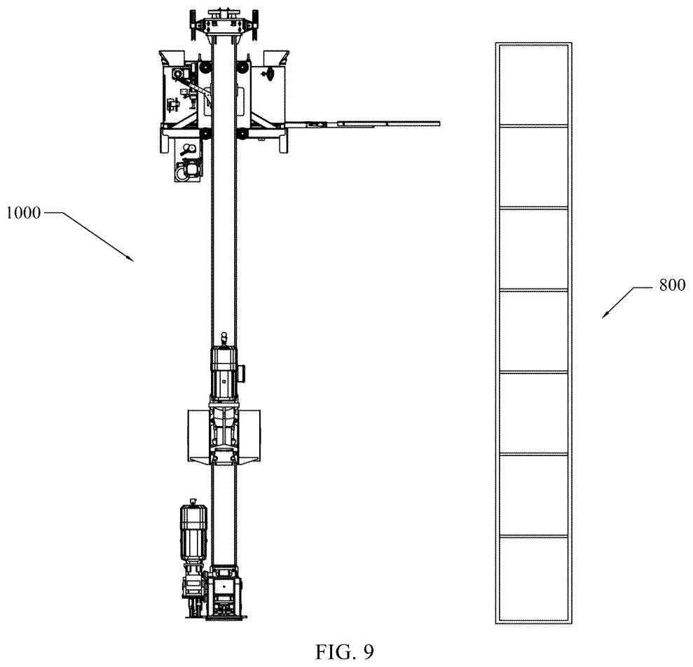

As shown in FIGS. 1 to 8, the detection mechanism 100 according to the embodiments of the present disclosure includes: a position detector 10, an anti-collision member 20 and an adjustment assembly 30.

According to some embodiments of the present disclosure, the position detector 10 has a contact 12 that is movable along the first direction. The anti-collision member 20 is movable relative to the position detector 10 between a first state and a second state along the first direction. The adjustment assembly 30 is connected between the anti-collision member 20 and the contact 12. When the anti-collision member 20 is in the first state, the contact 12 is in the triggering position and triggers the position detector 10 to send a collision signal. When the anti-collision member 20 is in the second state, the contact 12 is in the standby position, and the adjustment assembly 30 is movable relative to the anti-collision member 20 to adjust a distance between the triggering position and the standby position.

In other words, the detection mechanism 100 mainly includes the position detector 10, the anti-collision member 20 and the adjustment assembly 30. The detection mechanism 100 may be mounted on a movable structure (e.g., the fork arm 301 discussed in detail hereinafter) for collision detection.

The position detector 10 may be mounted on the movable structure and move together with the movable structure. The position detector 10 may detect the position of the item to be detected and send a signal according to the detection result.

The position detector 10 may include a contact 12. Contact 12 may be partially movable relative to the main body 200 of the position detector 10. The item to be detected may drive the contact 12 to move, and the position detector 10 may obtain the position of the item to be detected according to the position detection of the contact 12.

It should be noted that the position detector 10 has a detection accuracy, which is related to the stroke required for the contact 12 to trigger the position detector 10. When the contact 12 is not affected by an external force, the contact 12 may be in a free state. When the contact 12 moves a preset distance under the action of the item to be detected, the contact 12 may be in a triggering state, and at this point, the position detector 10 may be triggered and send a collision signal. That is to say, the contact 12 needs to move a corresponding stroke to trigger the position detector 10, generating a collision feedback. This stroke is the accuracy of the position detector 10.

For example, the stroke of the contact 12 may be 5 mm, that is, the item to be detected needs to push the contact 12 to move 5 mm to trigger the position detector 10, causing the position detector 10 to send a collision signal.

The anti-collision member 20 may be connected to the position detector 10, and the anti-collision member 20 is movable relative to the position detector 10. The anti-collision member 20 may be used as the item to be detected to push the contact 12 to move.

Specifically, the anti-collision member 20 is movable between the first state and the second state along the first direction. During the movement of the movable structure, the anti-collision member 20 may contact an obstacle prior to the movable structure and be pushed to move along the first direction, thereby pushing the contact 12 to move along the first direction to trigger the position detector 10.

As an example, when the stroke of the contact 12 is 5 mm, if the anti-collision member 20 directly pushes the contact 12 to move, the anti-collision member 20 needs to push the contact 12 to move 5 mm to cause the position detector 10 to send a collision signal, that is, the anti-collision member 20 itself needs to move 5 mm to cause the detection mechanism 100 to generate a collision feedback.

The adjustment assembly 30 may be connected between the anti-collision member 20 and the position detector 10. When the anti-collision member 20 collides with a foreign object and is displaced, the adjustment assembly 30 is displaced together with the contact 12 and the anti-collision member 20.

When the anti-collision member 20 is in the first state, the contact 12 may be in the triggering position, at this point, the position detector 10 is triggered and sends a collision signal, and the movable structure may stop moving according to the collision signal to reduce the damage caused by the collision.

When the anti-collision member 20 is in the second state, the contact 12 may be in the standby position, at this point, the anti-collision member 20 has not collided with an obstacle, and the position detector 10 has not been triggered.

The distance that the anti-collision member 20 moves during the process of moving from the second state to the first state may be L1, and the distance between the standby position and the triggering position may be L2, and L2=L1.

The adjustment assembly 30 may adjust the magnitude of L2, thereby adjusting the magnitude of L1. That is to say, the adjustment assembly 30 may adjust the stroke of the contact 12 moving from the standby position to the triggering position, thereby adjusting the collision stroke of the anti-collision member 20 corresponding to the triggering of the position detector 10.

If there is a need to shorten the collision stroke of the anti-collision member 20, the adjustment assembly 30 may be utilized. Under the condition that the anti-collision member 20 is in the second state, the original stroke corresponding to the contact 12 moving from the standby position to the triggering position is 5 mm. However, the adjustment assembly 30 may pre-compress the contact 12 by a certain distance. For example, the adjustment assembly 30 may compress the contact 12 by 2 mm, which changes the standby position of the contact 12. As such, the stroke corresponding to the contact 12 moving from the changed standby position to the triggering position becomes 3 mm. Therefore, after a collision, the anti-collision member 20 only needs to move 3 mm to push the contact 12 so as to trigger the position detector 10, thereby enabling the position detector 10 to send a collision signal. This is equivalent to improving the detection accuracy of the position detector 10 and shortening the displacement of the anti-collision member 20 required for generating the collision feedback.

By arranging the adjustment assembly 30 between the anti-collision member 20 and the position detector 10, the distance between the triggering position and the standby position of the contact 12 in the position detector 10 may be adjusted, that is, the stroke required for the contact 12 to trigger the position detector 10 to send a collision signal may be adjusted, so as to adjust a displacement of the anti-collision member 20 corresponding to the collision feedback generated by the detection mechanism 100. Therefore, the displacement may be shortened according to demand to improve the detection accuracy of the position detector 10, make the collision detection of the detection mechanism 100 more sensitive, and accelerate the collision response speed and reduce the harm of the collision.

In some embodiments, the adjustment assembly 30 may be a telescopic rod extending along the first direction. The telescopic rod may be driven by a driving member 400, such as a cylinder or the like, to adjust the position of the contact 12 under the condition that the anti-collision member 20 is in the second state according to demand.

In some embodiments, the detection mechanism 100 further includes: a fixing member 41, an extension rod 42, and a first elastic member 43. The fixing member 41 is fixedly arranged relative to the position detector 10. The extension rod 42 extends along the first direction. The first end of the extension rod 42 is connected to the anti-collision member 20, and the second end of the extension rod 42 is connected to the adjustment assembly 30. The first elastic member 43 is telescopic in the first direction and is connected between the anti-collision member 20 and the fixing member 41.

Moreover, the fixing member 41 may be fixedly mounted on the movable structure, and the relative position between the fixing member 41 and the position detector 10 may be fixed. The extension rod 42 may extend along the first direction. In the first direction, the first end of the extension rod 42 may be away from the position detector 10 and connected to the anti-collision member 20. The extension rod 42 may move synchronously with the anti-collision member 20. The second end of the extension rod 42 may be adjacent to the position detector 10 and connected to the adjustment assembly 30, so that the adjustment assembly 30 may move synchronously with the anti-collision member 20.

The first elastic member 43 may be connected between the fixing member 41 and the anti-collision member 20. The first elastic member 43 may be telescopic in the first direction. Under the condition that the anti-collision member 20 collides with an obstacle and drives the extension rod 42 to move towards the position detector 10 along the first direction, the anti-collision member 20 may compress the first elastic member 43. Under the condition that the anti-collision member 20 is separated from the obstacle, the anti-collision member 20 may be reset under the elastic force of the first elastic member 43, so that the anti-collision member 20 moves from the first state to the second state.

In some embodiments, the first elastic member 43 may be a spring. The first elastic member 43 may be sleeved on the extension rod 42. One end of the first elastic member 43 adjacent to the anti-collision member 20 may be connected to the anti-collision member 20, and one end of the first elastic member 43 away from the anti-collision member 20 may be connected to one end surface of the fixing member 41 facing the anti-collision member 20.

In the present embodiment, by arranging the fixing member 41 to cooperate with the first elastic member 43, the original rigid collision of the anti-collision member 20 may be changed into a flexible collision, reducing the impact force generated by the collision and reducing the damage caused by the collision. In addition, the first elastic member 43 may also cause the anti-collision member 20 to automatically reset after the collision.

In some implementations, the adjustment assembly 30 includes: an adjustment member 35, a push rod 32 and a second elastic member 33. The adjustment member 35 is connected to the second end of the extension rod 42, and the adjustment member 35 is movable relative to the extension rod 42 along the first direction. The adjustment member 35 is provided with a first limit portion 311. The push rod 32 extends along the first direction. One end of the push rod 32 away from the anti-collision member 20 abuts against the contact 12. The push rod 32 is provided with a first matching portion 321. The first matching portion 321 is located on a side of the first limit portion 311 adjacent to the anti-collision member 20. The second elastic member 33 is telescopic in the first direction. The first end of the second elastic member 33 abuts against the extension rod 42, and the second end of the second elastic member 33 abuts against the push rod 32, and presses the first matching portion 321 against the first limit portion 311.

The adjustment assembly 30 in the present embodiment may mainly include an adjustment member 35, a push rod 32 and a second elastic member 33.

The adjustment member 35 may be connected to one end of the extension rod 42 away from the anti-collision member 20, and the adjustment member 35 may move along the first direction, thereby changing the distance between the adjustment member 35 and the anti-collision member 20.

The push rod 32 may extend along the first direction. In the first direction, one end of the push rod 32 away from the anti-collision member 20 may abut against the contact 12, so that when the push rod 32 moves towards the position detector 10 along the first direction, the push rod 32 may push the contact 12 to trigger the position detector 10.

One end of the push rod 32 adjacent to the anti-collision member 20 may be movably connected to the adjustment member 35. The adjustment member 35 may be provided with a first limit portion 311, and the push rod 32 may be provided with a first matching portion 321. In the first direction, the first matching portion 321 may be located on a side of the first limit portion 311 adjacent to the anti-collision member 20, and the first limit portion 311 may limit the push rod 32 through the first matching portion 321.

For the convenience of description, a positive direction of the first direction may be defined as the direction in which the anti-collision member 20 faces the position detector 10, and a reverse direction of the first direction may be defined as the direction in which the position detector 10 faces the anti-collision member 20.

The second elastic member 33 may be connected between the push rod 32 and the extension rod 42. The second elastic member 33 may be telescopic in the first direction. The two ends of the second elastic member 33 abut against the extension rod 42 and the push rod 32, respectively. The extension rod 42 and the push rod 32 are respectively subjected to the elastic force of the second elastic member 33. Under the elastic force of the second elastic member 33, the first matching portion 321 may be pressed against the first limit portion 311 to prevent the push rod 32 from continuing to move in the positive direction of the first direction.

Since the adjustment member 35 is movable relative to the extension rod 42 along the first direction, and under the action of the second elastic member 33, the first matching portion 321 on the push rod 32 always presses against the first limit portion 311. Therefore, the relative position between the push rod 32 and the adjustment member 35 is fixed. The adjustment member 35 may adjust the position of the push rod 32 relative to the anti-collision member 20 by adjusting its own position, thereby driving the push rod 32 to pre-compress the contact 12.

For example, when there is a need to shorten the displacement of the anti-collision member 20 required for generating the collision feedback from 5 mm to 3 mm, the adjustment member 35 may be caused to move 2 mm in a direction away from the anti-collision member 20, which in turn drives the second elastic member 33 and the push rod 32 to move 2 mm in the direction away from the anti-collision member 20, so that the push rod 32 pre-compresses the contact 12 by 2 mm. Thus, under the condition that the anti-collision member 20 collides, the anti-collision member 20 only needs to move 3 mm to cause the contact 12 to be in the triggering position. Note the displacement of the anti-collision member 20 may be adjusted to a value as required.

In some implementations, the push rod 32 and the adjustment member 35 may be arranged at intervals along the radial direction of the push rod 32. The first limit portion 311 may be a protrusion on the adjustment member 35 protruding towards the push rod 32. The first matching portion 321 may be a protrusion on the push rod 32 protruding towards the adjustment member 35. The two protrusions may abut against each other in the first direction.

According to some embodiments, the adjustment member 35 includes a sleeve 31 and a nut 34. The sleeve 31 extends along the first direction. The first end of the sleeve 31 is sleeved on the second end of the extension rod 42 and screwed with the extension rod 42. One end of the push rod 32 adjacent to the anti-collision member 20 extends into the second end of the sleeve 31. The first limit portion 311 is provided on the inner wall surface of the sleeve 31 and protrudes into the sleeve 31. The first matching portion 321 is provided on the outer circumferential surface of the push rod 32 and protrudes outward. The second elastic member 33 is provided in the sleeve 31. The nut 34 is screwed with the extension rod 42, and the nut 34 is located on a side of the sleeve 31 away from the contact 12 to limit the sleeve 31.

The adjustment member 35 may mainly include a sleeve 31 and a nut 34. The outer surface of the extension rod 42 may be provided with an external thread, and the sleeve 31 and the nut 34 may be provided with an internal thread. The sleeve 31 and the nut 34 may be respectively screwed with the second end of the extension rod 42, and the nut 34 may be located on a side of the sleeve 31 adjacent to the anti-collision member 20. By rotating the sleeve 31 or the nut 34, the sleeve 31 or the nut 34 may be caused to move along the extension rod 42 to adjust the positions of the sleeve 31 and the nut 34. Among them, the nut 34 may limit the position of the sleeve 31 in the first direction to lock the sleeve 31.

In addition, the sleeve 31 may be of a hollow structure. One end of the push rod 32 adjacent to the anti-collision member 20 may extend into the hollow structure of the sleeve 31, and the second elastic member 33 may also be accommodated in the sleeve 31. The inner wall surface of the sleeve 31 may be provided with a first limit portion 311 protruding inward, and the outer surface of the push rod 32 may be provided with a first matching portion 321 protruding outward. The first limit portion 311 may be a limit stair, and the first matching portion 321 may have a matching surface 3211. The matching surface may abut against the stair surface of the limit stair to limit the push rod 32 in the positive direction of the first direction.

In the present embodiment, since the sleeve 31 and the nut 34 are respectively screwed with the extension rod 42, by rotating the sleeve 31 and the nut 34, the position of the sleeve 31 on the extension rod 42 may be adjusted. By utilizing the elastic force of the second elastic member 33 on the push rod 32 and the limitation of the first limit portion 311 on the first matching portion 321, the position of the push rod 32 relative to the extension rod 42 may be adjusted, so that the push rod 32 may pre-compress the contact 12 in advance, which in turn adjusts the collision stroke of the anti-collision member 20.

In addition, arranging the second elastic member 33 may change the rigid touch between the push rod 32 and the contact 12 into a flexible touch, which reduces the impact. This causes the collision process of the detection mechanism 100 to be gentler and smoother, and is beneficial to reducing the damage caused by the collision.

In some embodiments, the second end of the extension rod 42 may be provided with a prolonged rod, the diameter of the prolonged rod may be less than the diameter of the second end of the extension rod 42. A channel may be provided in the push rod 32, the channel may penetrate the push rod 32 along the first direction. A stair may be provided in the channel. The second elastic member 33 may be a spring, one end of the spring adjacent to the anti-collision member 20 may be sleeved on the prolonged rod, and one end of the spring away from the anti-collision member 20 may extend into the channel of the push rod 32 and abut against the stair, so that the spring applies a force in the positive direction of the first direction to the push rod 32.

In some embodiments, the push rod 32, the extension rod 42 and the sleeve 31 may be coaxially arranged.

According to other embodiments, one end of the fixing member 41 away from the anti-collision member 20 is provided with a second limit portion 411. The extension rod 42 is provided with a second matching portion 421. The second matching portion 421 is located on a side of the second limit portion 411 away from the anti-collision member 20. When the anti-collision member 20 is in the first state, the second limit portion 411 is spaced apart from the second matching portion 421, and when the anti-collision member 20 is in the second state, the second limit portion 411 abuts against the second matching portion 421.

In some embodiments, the fixing member 41 may be provided with a second limit portion 411, and the second limit portion 411 is located at one end of the fixing member 41 away from the anti-collision member 20. The extension rod 42 may be provided with a second matching portion 421 that cooperates with the first limit portion 311. The first limit portion 311 may be located on a side of the second matching portion 421 adjacent to the anti-collision member 20 to limit the extension rod 42 in the reverse direction of the first direction.

Under the condition that the anti-collision member 20 does not collide with an obstacle, the anti-collision member 20 causes the first matching portion 321 to abut against the first limit portion 311 under the elastic force of the first elastic member 43, and at this point, the anti-collision member 20 is in the second state.

Under the condition that the anti-collision member 20 collides with an obstacle and moves to the first state, the first elastic member 43 is compressed, and the second limit portion 411 and the second matching portion 421 may be spaced apart along the first direction.

In the present embodiment, through the cooperation between the second limit portion 411 on the fixing member 41 and the second matching portion 421 on the extension rod 42, the position of the anti-collision member 20 in the second state may be relatively fixed. In particular, no matter how the adjustment assembly 30 moves, under the condition that the anti-collision member 20 is in the second state, the distance between the anti-collision member 20 and the fixing member 41, as well as the distance between the anti-collision member 20 and the main body 200 of the position detector 10, remains unchanged. By adjusting the distance between the adjustment assembly 30 and the anti-collision member 20, the adjustment assembly 30 may pre-compress the contact 12, thereby adjusting the collision stroke of the anti-collision member 20.

In some embodiments, one end surface of the fixing member 41 away from the anti-collision member 20 may be provided with a limit groove. The limit groove may be recessed in the direction facing the anti-collision member 20. The bottom surface of the limit groove may form the second limit portion 411. The first matching portion 321 may be an annular boss 322. The annular boss may protrude outward along the radial direction of the extension rod 42. One side surface of the annular boss adjacent to the anti-collision member 20 may abut against the bottom surface of the limit groove to limit the extension rod 42 in the reverse direction of the first direction.

In some implementations, the fixing member 41 is a linear bearing. The linear bearing is sleeved on the extension rod 42. Thus, the extension rod 42 may move along the axis of the linear bearing, which is beneficial to reducing the friction between the extension rod 42 and the fixing member 41 and making the collision feedback more sensitive.

According to some embodiments, the position detector 10 is a wireless limit switch. The contact 12 of the wireless limit switch may extend out of the body of the wireless limit switch and abut against the push rod 32. The push rod 32 may pre-compress the contact 12 so that a portion of the contact 12 is pressed into the wireless limit switch under the condition that the anti-collision member 20 is not collided.

In addition, the wireless limit switch may send a collision signal by means of wireless transmission, thus the cable for connecting the limit switch may be omitted. Since the wireless limit switch needs to move together with the movable structure during the movement of the movable structure, the cable may also move accordingly, resulting in a shortened service life of the cable. The wireless limit switch in the present embodiment may omit the cable to solve the problem of the service life of the cable.

The embodiments of the present disclosure also provide a stacker crane 1000, which includes a main body 200, a supporting member 300, a driving member 400 and a detection mechanism 100, as shown in FIGS. 4-7. The supporting member 300 is movably arranged on the main body 200 along the first direction, and the supporting member 300 is used for supporting an item 600. The driving member 400 is connected to the supporting member 300 and drives the supporting member 300 to move along the first direction. The stacker 400 may use any of the embodiments of the detection mechanism 100 described herein. The position detector 10 may be arranged on the supporting member 300, and the anti-collision member 20 may protrude from the supporting member 300 in the first direction.

The stacker crane may be arranged in a warehouse, and the warehouse may accommodate shelves. Item 600 may be goods, such as batteries or the like. In other embodiments, item 600 may be other goods besides batteries or the like. The shelves in the warehouse may store batteries or the like, but other goods besides batteries or the like may be stored. The stacker crane may pick up item 600 from the shelves or transport item 600 to the shelves for storage. The stacker crane may handle storing and retrieving one or more items, like item 600, from the shelves.

The main body 200 of the stacker crane may walk between the shelves. The supporting member 300 is movably connected to the main body 200 to transport item 600 to the shelves or pick up the goods from the shelves. The driving member 400 may be arranged on the main body 200 and connected to the supporting member 300 to drive the supporting member 300 to move along the first direction. In some cases, the driving member 400 may be a driving motor.

The detection mechanism 100 may be arranged on the supporting member 300. Moreover, the position detector 10 and the fixing member 41 may be fixedly connected to the supporting member 300. The anti-collision member 20 may protrude from the supporting member 300 in the first direction.

For the convenience of description, one end of the supporting member 300 adjacent to the shelf 800 to be accessed in the first direction may be defined as the front end of the supporting member 300, and one end of the supporting member 300 away from the shelf to be accessed may be defined as the rear end of the supporting member 300. The anti-collision member 20 may protrude from the front end of the supporting member 300, or from the rear end of the supporting member 300, or from both the front end and the rear end of the supporting member 300, which is not limited herein.

When the supporting member 300 moves along the first direction, the anti-collision member 20 on the detection mechanism 100 may contact an obstacle prior to the supporting member 300 and the goods on the supporting member 300. The obstacle may be a shelf, goods on the shelf, or related items. Under the action of the obstacle, the anti-collision member 20 moves from the second state to the first state, triggers the position detector 10 to cause the position detector 10 to send a collision signal, and then the driving member 400 may stop driving the supporting member 300 according to the collision signal, so that the supporting member 300 stops moving. Thus, the operation may be stopped before the supporting member 300 hits the obstacle, so as to protect the obstacle and the stacker crane and prevent the goods on the shelf from falling and being damaged.

Since the detection mechanism 100 according to the embodiments of the present disclosure has the above technical effects, the stacker crane according to the embodiments of the present disclosure also has corresponding technical effects, that is, the displacement of the anti-collision member 20 corresponding to the collision feedback generated by the detection mechanism 100 may be adjusted, the displacement may be shortened according to demand to improve the detection accuracy of the position detector 10, make the collision detection of the detection mechanism 100 more sensitive, accelerate the collision response speed and reduce the harm of the collision.

According to other embodiments, the anti-collision member 20 is an anti-collision plate. The projection of the anti-collision plate along the first direction covers the projection of the supporting member 300 along the first direction.

For the convenience of description, a projection plane may be defined and perpendicular to the first direction. The projection of the anti-collision plate along the first direction on the projection plane may cover the projection of the supporting member 300 along the first direction on the projection plane. Thus, the anti-collision plate may provide comprehensive protection for the front end and/or the rear end of the supporting member 300, ensuring that the anti-collision plate may collide with the obstacle prior to the supporting member 300. This may trigger the wireless limit switch to send a collision signal during the process of the anti-collision plate being hit, ensuring the supporting member 300 stops the operation before contacting the obstacle and thus serving the purpose of protecting the obstacle.

In addition, the anti-collision plate may be spaced apart from the supporting member 300 in the first direction to reserve a space for the displacement generated by the collision of the anti-collision plate.

In some implementations, the anti-collision plate is recessed towards the supporting member 300 and forms an avoidance groove 21. Thus, some structures on the shelf may be avoided through the avoidance groove 21. For example, the shelf may be provided with an auxiliary sensor for auxiliary transportation, and the avoidance groove 21 may avoid the auxiliary sensor to prevent the anti-collision plate from colliding with the auxiliary sensor and damaging the auxiliary sensor.

In some implementations, the avoidance groove 21 may be a U-shaped groove, and the U-shaped groove may be symmetrically arranged on the anti-collision plate.

According to some embodiments of the present disclosure, the stacker crane may include two separate detection mechanisms 100. The two detection mechanisms 100 are arranged at two ends of the supporting member 300 in the first direction, respectively.

In some embodiments, one of the two detection mechanisms 100 may be arranged at the front end of the supporting member 300, and another one of the two detection mechanisms 100 may be arranged at the rear end of the supporting member 300. Therefore, the front end and the rear end of supporting member 300 are each provided with an anti-collision plate. The two anti-collision plates may be spaced apart from the front end and the rear end of the supporting member 300, respectively.

In some embodiments, the two detection mechanisms 100 may respectively play an anti-collision role under a condition that the supporting member 300 extends out of the main body 200 or retracts into the main body 200 along the first direction and provide anti-collision protection for the shelves in front of and behind the supporting member 300.

According to other embodiments, the supporting member 300 may include two fork arms 301. The two fork arms 301 may extend along the first direction, respectively, and the two fork arms 301 may be spaced apart in the second direction. The second direction may intersect with the first direction. The position detector 10 may be arranged on one of the two fork arms 301. A guiding mechanism 700 may be arranged on another one of the two fork arms 301 for guiding the anti-collision member 20 to move along the first direction.

In some embodiments, the supporting member 300 may mainly include two fork arms 301. Each fork arm 301 may be of a rod-shaped structure, and each fork arm 301 may extend along the first direction. The two fork arms 301 may be spaced apart along the second direction. The second direction may be perpendicular to the first direction.

In some embodiments, one of the two fork arms 301 may be provided with the detection mechanism 100, and one of the two fork arms 301 may be provided with the guiding mechanism 700. The guiding mechanism 700 may be connected to the anti-collision member 20 and guide the anti-collision member 20 to move along the first direction.

In some implementations, the guiding mechanism 700 may include a linear bearing 701, a guide rod 702, and a third elastic member 703. The linear bearing may be fixed on the fork arms 301. One end of the guide rod may be connected to the anti-collision member 20, and another end of the guide rod may extend into the linear bearing. The guide rod may move along the first direction. The third elastic member may be connected between the anti-collision member 20 and the linear bearing of the guiding mechanism 700.

Under the condition that the anti-collision member 20 is hit, the anti-collision member 20 may be displaced, thereby pushing the extension rod 42 and the guide rod to move along the corresponding linear bearing. With the guidance of the linear bearing on the extension rod 42 and the guide rod, it may be ensured that the anti-collision member 20 moves integrally along the first direction, preventing any shaking of the anti-collision member 20 that could affect the triggering of the collision signal.

In some implementations, the stacker crane further includes a wireless receiver 500. The wireless receiver 500 may be wirelessly connected to the position detector 10 to receive the collision signal. The wireless receiver 500 may be electrically connected to the driving member 400 and may control the driving member 400 according to the collision signal.

In another implementation, the wireless receiver 500 may cooperate with the wireless limit switch. Under the condition that the wireless limit switch is triggered, the wireless limit switch may send a collision signal to the wireless receiver 500 by means of wireless transmission. Then, after the wireless receiver 500 receives the collision signal, it may control the driving member 400 to stop working, so that the supporting member 300 stops moving and the obstacle is prevented from being damaged due to the collision of the supporting member 300 with the obstacle.

Although some specific embodiments of the present disclosure have been described in detail by examples, the person having ordinary skill in the art should understand that the above examples are merely for illustration and are not intended to limit the scope of the present disclosure. The person having ordinary skill in the art should understand that the above embodiments may be modified without departing from the scope and spirit of the present disclosure. The scope of the present disclosure is defined by the appended claims.

What is claimed is:

1. A detection mechanism, comprising:
a position detector, the position detector having a contact that is movable along a first direction;
an anti-collision member, the anti-collision member movable relative to the position detector between a first state and a second state along the first direction; and
an adjustment assembly, the adjustment assembly connected between the anti-collision member and the contact,
wherein when the anti-collision member is in the first state, the contact is in a triggering position and triggers the position detector to send a collision signal, and when the anti-collision member is in the second state, the contact is in a standby position,
wherein the adjustment assembly is movable relative to the anti-collision member to adjust a distance between the triggering position and the standby position.

2. The detection mechanism according to claim 1, further comprising:
a fixing member, the fixing member fixedly arranged relative to the position detector;
an extension rod, the extension rod extending along the first direction, a first end of the extension rod connected to the anti-collision member, and a second end of the extension rod connected to the adjustment assembly; and
a first elastic member, the first elastic member being telescopic in the first direction, and the first elastic member connected between the anti-collision member and the fixing member.

3. The detection mechanism according to claim 2, wherein the adjustment assembly comprises:
an adjustment member, the adjustment member connected to the second end of the extension rod, and movable relative to the extension rod along the first direction, the adjustment member provided with a first limit portion;
a push rod, the push rod extending along the first direction, one end of the push rod away from the anti-collision member abutting against the contact, the push rod provided with a first matching portion, the first matching portion located on a side of the first limit portion adjacent to the anti-collision member; and
a second elastic member, the second elastic member being telescopic in the first direction, a first end of the second elastic member abutting against the extension rod, a second end of the second elastic member abutting against the push rod, and pressing the first matching portion against the first limit portion.

4. The detection mechanism according to claim 3, wherein the adjustment member comprises:
a sleeve, the sleeve extending along the first direction, a first end of the sleeve being sleeved on the second end of the extension rod and screwed with the extension rod, one end of the push rod adjacent to the anti-collision member extending into a second end of the sleeve, the first limit portion being provided on an inner wall surface of the sleeve and protruding into the sleeve, the first matching portion being provided on an outer circumferential surface of the push rod and protruding outward, and the second elastic member provided in the sleeve; and
a nut, the nut being screwed with the extension rod, and the nut located on a side of the sleeve away from the contact to limit the sleeve.

5. The detection mechanism according to claim 2, wherein one end of the fixing member away from the anti-collision member is provided with a second limit portion, the extension rod is provided with a second matching portion, the second matching portion is located on a side of the second limit portion away from the anti-collision member,
wherein when the anti-collision member is in the first state, the second limit portion is spaced apart from the second matching portion, and when the anti-collision member is in the second state, the second limit portion abuts against the second matching portion.

6. The detection mechanism according to claim 2, wherein the fixing member is a linear bearing, and the linear bearing is sleeved on the extension rod.

7. The detection mechanism according to claim 1, wherein the position detector is a wireless limit switch.

8. The detection mechanism according to claim 2, wherein the first elastic member is a spring and sleeved on the extension rod, one end of the first elastic member adjacent to the anti-collision member is connected to the anti-collision member, and one end of the first elastic member away from the anti-collision member is connected to one end surface of the fixing member facing the anti-collision member.

9. The detection mechanism according to claim 3, wherein the push rod and the adjustment member are arranged at intervals along a radial direction of the push rod, the first limit portion is a first protrusion on the adjustment member protruding towards the push rod, the first matching portion is a second protrusion on the push rod protruding towards the adjustment member, the first protrusion and the second protrusion abut against each other in the first direction.

10. The detection mechanism according to claim 3, wherein the second end of the extension rod is provided with a prolonged rod, the prolonged rod includes a diameter less than a diameter of the second end of the extension rod, the push rod comprises a channel, the channel penetrates the push rod along the first direction, the channel includes a stair, the second elastic member is a spring, one end of the spring is adjacent to the anti-collision member sleeved on the prolonged rod, one end of the spring away from the anti-collision member extends into the channel of the push rod and abutting against the stair.

11. The detection mechanism according to claim 4, wherein the push rod, the extension rod, and the sleeve are coaxially arranged.

12. The detection mechanism according to claim 5, wherein one end surface of the fixing member away from the anti-collision member is provided with a limit groove, the limit groove is recessed in a direction facing the anti-collision member, a bottom surface of the limit groove forms the second limit portion, the first matching portion is an annular boss, the annular boss protrudes outward along a radial direction of the extension rod, one side surface of the annular boss adjacent to the anti-collision member abuts against the bottom surface of the limit groove.

13. A stacker crane, comprising:
a main body;
a supporting member, the supporting member movably arranged on the main body along the first direction, and the supporting member used for supporting a member to be supported;
a driving member, the driving member connected to the supporting member and driving the supporting member to move along the first direction; and
at least one detection mechanism, the at least one detection mechanism comprising:
a position detector, the position detector having a contact movable along a first direction;
an anti-collision member, the anti-collision member movable relative to the position detector between a first state and a second state along the first direction; and
an adjustment assembly, the adjustment assembly connected between the anti-collision member and the contact,
wherein when the anti-collision member is in the first state, the contact is in a triggering position and triggers the position detector to send a collision signal, and when the anti-collision member is in the second state, the contact is in a standby position,
wherein the adjustment assembly is movable relative to the anti-collision member to adjust a distance between the triggering position and the standby position, the position detector is arranged on the supporting member, and the anti-collision member protrudes from the supporting member in the first direction.

14. The stacker crane according to claim 13, wherein the anti-collision member is an anti-collision plate, and a projection of the anti-collision plate along the first direction covers a projection of the supporting member along the first direction.

15. The stacker crane according to claim 14, wherein the anti-collision plate is recessed towards the supporting member and forms an avoidance groove.

16. The stacker crane according to claim 13, wherein the at least one detection mechanism includes two detection mechanisms, and the two detection mechanisms are respectively arranged at two ends of the supporting member in the first direction.

17. The stacker crane according to claim 13, wherein the supporting member comprises two fork arms, the two fork arms respectively extend along the first direction and are spaced apart in a second direction, the second direction intersecting with the first direction, the position detector is arranged on one of the two fork arms, and a guiding mechanism is arranged on another one of the two fork arms for guiding the anti-collision member to move along the first direction.

18. The stacker crane according to claim 13, further comprising:
a wireless receiver, the wireless receiver wirelessly connected to the position detector to receive the collision signal, and the wireless receiver electrically connected to the driving member and configured to control the driving member according to the collision signal.

19. The stacker crane according to claim 13, wherein the adjustment assembly is a telescopic rod extending along the first direction, the telescopic rod is driven by the driving member.

20. The stacker crane according to claim 12, wherein the guiding mechanism includes a linear bearing, a guide rod, and a third elastic member, the linear bearing is fixed on the fork arms, one end of the guide rod is connected to the anti-collision member and another end of the guide rod extends into the linear bearing, the guide rod is moveable along the first direction, the third elastic member is connected between the anti-collision member and the linear bearing of the guiding mechanism.
